(19) United States
(12) Patent Application Publication
(10) Pub. No.: US 2012/0177889 A1
(43) Pub. Date: Jul. 12, 2012

(54) NONWOVEN FABRIC AND METHOD FOR MANUFACTURING SAME

(75) Inventors: Katsuhiro Uematsu, Kanonji-shi (JP); Hiroki Goda, Kanonji-shi (JP); Satoshi Mizutani, Kanonji-shi (JP)

(73) Assignee: UNICHARM CORPORATION, Shikokuchuo-shi, Ehime (JP)

(21) Appl. No.: 13/497,084

(22) PCT Filed: Aug. 16, 2010
(86) PCT No.: PCT/JP2010/063802

§ 371 Date: Mar. 20, 2012

(30) Foreign Application Priority Data
Sep. 29, 2009 (JP) 2009-225523

(51) Int. Cl. B32B 3/30; D04H 3/08

(52) U.S. Cl. 428/167; 156/181

(57) ABSTRACT

Provided is a liquid-permeable nonwoven fabric having improved in air permeability in the thickness direction thereof, formed on its surface with ridges and troughs extending in parallel to each other in one direction. A nonwoven fabric formed of thermoplastic synthetic short fibers fused together is formed on its upper surface with ridges and troughs extending in parallel to each other in a longitudinal direction. In a cross section of each ridge taken in the transverse direction, the ridge includes opposite lateral regions in which the short fibers are densely distributed and a central region defined between the opposite lateral regions and in which the short fibers are sparsely distributed. The short fibers in the central region include short fibers in a crest of the ridge adapted to connect the opposite lateral regions to each other. This invention also discloses a method for manufacturing of the nonwoven fabric.

### CROSS-REFERENCE TO RELATED APPLICATION

This application is a National Stage of International Application Number PCT/JP2010/063802 filed on Aug. 16, 2010, which is based upon and claims the benefit of priority from Japanese Patent Application Number 2009-225523 filed on Sep. 29, 2009.

### TECHNICAL FIELD

This invention relates to nonwoven fabrics and methods for manufacturing the same and, more particularly, to various types of nonwoven fabrics suitable to be used as liquid-permeable topsheets of disposable bodily fluid-absorbent articles such as disposable diapers and sanitary napkins and methods for manufacturing such nonwoven fabrics.

### BACKGROUND

Conventionally, nonwoven fabrics formed of thermoplastic synthetic fibers are known as one of various types of liquid-permeable topsheets used for disposable bodily-fluid absorbent articles. It is also known to use a nonwoven fabric formed on its skin-contactable surface with ridges and troughs as the topsheet so that the contact area between the bodily fluid-absorbent article wearer's skin and the topsheet may be reduced and thereby a feeling of wetness which would otherwise be created by the topsheet to the wearer's skin may be alleviated. For example, in one of the nonwoven fabrics disclosed in JP 2009-030218 A (PTL 1), the skin-contactable surface is formed with a plurality of ridges extending in one direction in parallel to each other and a plurality of troughs, each defined between each pair of the adjacent ridges, extending in the same direction. This nonwoven fabric is obtained by following the steps of: loading a fibrous web having an uniform basis mass in a machine direction as well as in a cross direction on an air-permeable belt, conveying the fibrous web in the machine direction, and subjecting the fibrous web to ejection of heated air jets from a plurality of nozzles arranged at predetermined pitches in the cross direction.

### CITATION LIST

### Patent Literature

PTL 1: JP 2009-030218 A

### SUMMARY

### Technical Problem

In the aforementioned nonwoven fabric, the web being conveyed in the machine direction is formed in regions immediately below the nozzles with the troughs and in regions below the respective intermediate positions respectively defined between the adjacent nozzles with the ridges. Specifically, the respective ridges are formed in such a way that the constituent fibers otherwise supposed to form the troughs are partially forced under the effect of the air jets to migrate in the cross direction and to gather together in the regions below the respective intermediate positions respectively defined between the adjacent nozzles. In the ridges formed in this manner, it is generally difficult to assure a high air-permeability in a thickness direction of the nonwoven fabric.

An object of this invention is to make improvements to such a liquid-permeable nonwoven fabric formed on its surface with ridges and troughs extending in parallel to each other in one direction so that the air-permeability in the thickness direction thereof may be improved.

### Solution to Problem

The present invention includes a first aspect relating to a nonwoven fabric and a second aspect relating to a method for manufacturing this nonwoven fabric.

The first aspect of this invention relates to a nonwoven fabric formed of thermoplastic synthetic resin short fibers fused together having a longitudinal direction, a transverse direction and a thickness direction being orthogonal to each other, including an upper surface and a lower surface opposite to the upper surface as viewed in the thickness direction wherein the upper surface is formed with ridges and troughs extending in parallel to each other and alternating in the transverse direction so as to undulate in the transverse direction.

In such a nonwoven fabric, the first aspect of this invention resides in that, in a cross section taken in the transverse direction, each of the ridges includes opposite lateral regions in which the short fibers are densely distributed and a central region defined between the opposite lateral regions in which the short fibers are sparsely distributed, and the short fibers in the central region include the short fibers extending in a crest of the ridge in the transverse direction to connect the opposite lateral regions.

According to one embodiment of this invention on the first aspect thereof, in a state of the nonwoven fabric placed on a horizontal plane so that the lower surface may rest on the horizontal plane, the upper surface in the opposite lateral regions lies at a height in a range of 1 to 5 mm from the horizontal plane and the upper surface in the trough lies at a height lower than the height of the opposite lateral region, i.e., in a range of 0.1 to 2 mm from the horizontal plane.

According to another embodiment of this invention on the first aspect thereof, in the ridge of the nonwoven fabric placed on the horizontal plane and subjected to a load of 3 gf/cm² from the side of the upper surface by means of a flat plate stacked on the upper surface, the number of intersections N₁ of a vertical line Y₁ extending through the central region and the short fibers is smaller than any one of the number of intersections N₂, N₃ of vertical lines Y₂ and Y₃ extending through the opposite lateral regions and the short fibers.

The second aspect of this invention relates to a method for manufacturing the nonwoven fabric according to the first aspect of this invention.

The second aspect of this invention resides in that the method for manufacturing the nonwoven fabric includes the steps of:

(a) Placing a web formed of thermoplastic synthetic resin short fibers and having an upper surface and a lower surface on air-permeable supporting means, conveying the web in a machine direction under a suction effect provided from below the support means, and subjecting the upper surface of the web to ejection of heated first air jets to from a plurality of first nozzles arranged at a required pitch in across section being orthogonal to the machine direction to obtain a first processed web having the upper surface formed with a plurality of first ridges and first troughs arranged alternately in the cross direction and extending in parallel to each other in the machine direction;

(b) Subjecting the upper surface in the respective first ridges of the first processed web running in the machine direction to ejection of heated second air jets from a plurality of second nozzles arranged at a required pitch in the cross direction to obtain a second processed web including, in the cross section in the cross direction, a central region defined between the opposite lateral regions in which the short fibers are densely distributed and the short fibers are distributed more sparsely than in the opposite lateral regions and additionally including a plurality of second ridges extending in the machine direction and a plurality of second troughs defined between the adjacent second ridges and extending in the machine direction; and

(c) Heat-treating the second processed web to fuse the short fibers together.

### Advantageous Effects of Invention

In the nonwoven fabric according to this invention, each of the ridges extending in parallel to each other in one direction has its cross section formed of the opposite lateral regions and the central region and the short fibers are densely distributed in the opposite lateral region, and sparsely distributed in the central region. In consequence, regardless of the presence of the ridges, the nonwoven fabric may assure sufficient air-permeability. In addition, the upper surface of the nonwoven fabric can ensure smooth and comfortable texture since the crests of the opposite lateral regions are connected by the short fibers extending in the transverse direction in the central regions.

### BRIEF DESCRIPTION OF DRAWINGS

FIG. 1 is a photograph showing a perspective view of a nonwoven fabric.

FIG. 2 is a diagram schematically illustrating the nonwoven fabric of FIG. 1.

FIG. 3 is a photograph showing a cross-section of the nonwoven fabric of FIG. 1 taken along in the cross direction.

FIG. 4 is a diagram partially illustrating a process for manufacturing the nonwoven fabric.

FIG. 5 is a sectional diagram taken along line V-V in FIG. 4.

FIG. 6 is a sectional diagram taken along line VI-VI in FIG. 4.

FIG. 7 is a diagram illustrating a mechanism according to which each of ridges is formed with a middle area and opposite lateral regions.

### DESCRIPTION OF EMBODIMENTS

Details of the nonwoven fabric according to this invention and the method for manufacturing the same will be described hereunder with reference to the accompanying drawings.

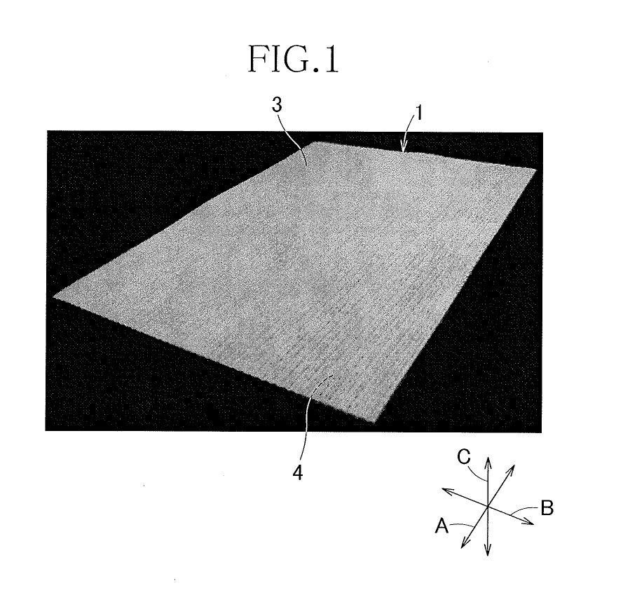

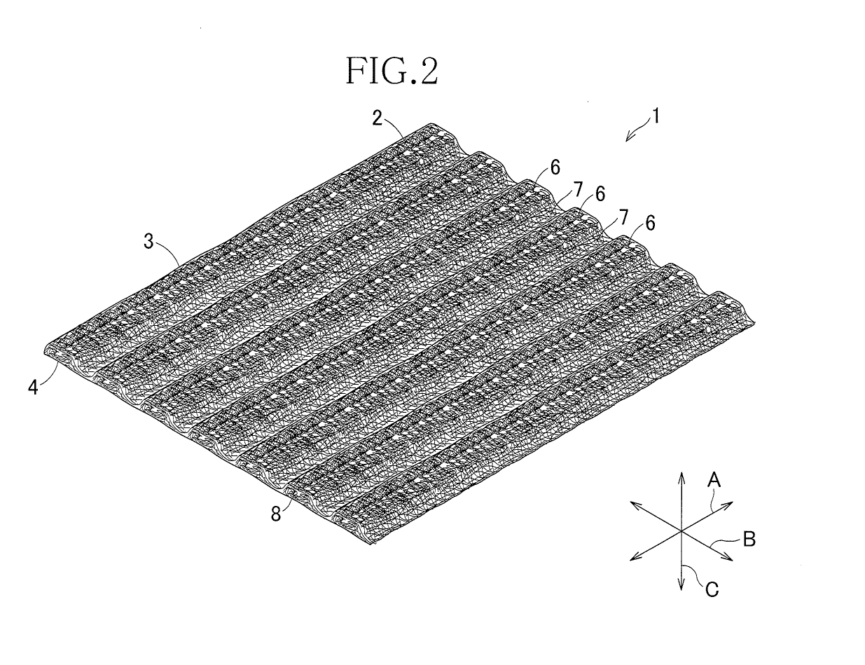

FIG. 1 is a perspective view (photograph) of a nonwoven fabric 1 and FIG. 2 is a diagram schematically illustrating the nonwoven fabric 1. The nonwoven fabric 1 is formed of short fibers 2 of thermoplastic synthetic resin and has an upper surface 3 and a lower surface 4 opposite to the upper surface 3. In FIGS. 1 and 2, a longitudinal direction, a transverse direction and a thickness direction which are orthogonal to each other are indicated by double-headed arrows A, B and C, respectively. The upper surface 3 is formed with a plurality of ridges 6 and a plurality of troughs 7 extending in parallel to each other in the longitudinal direction A and these ridges 6 and the troughs 7 are arranged alternately in the transverse direction B. The lower surface 4 is substantially flat. FIG. 2 illustrates also a cross-section 8 of the nonwoven fabric 1 cut in the transverse direction B to extend across the ridges 6 and the troughs 7.

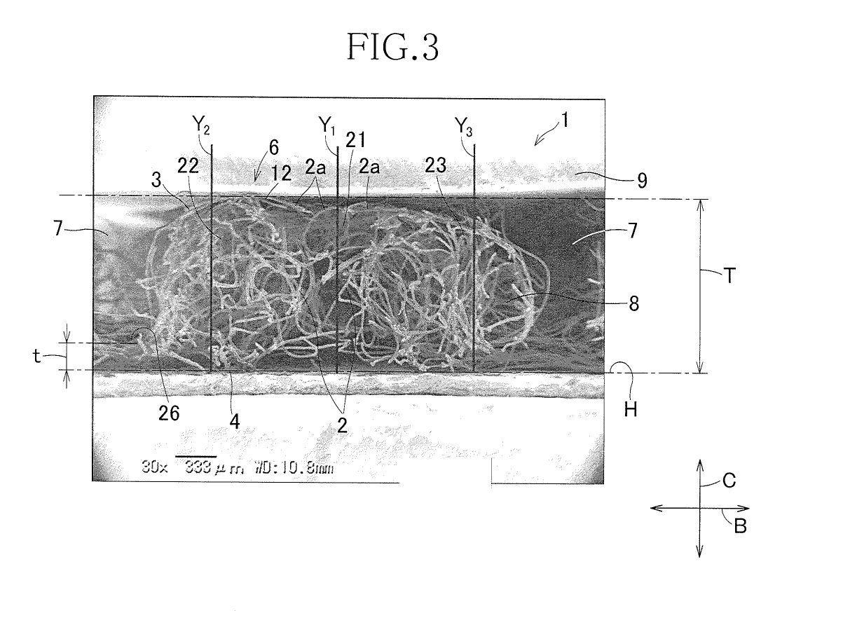

FIG. 3 is a photograph of 30-fold magnifications partially showing the cross-section 8 (See FIG. 2) of the nonwoven fabric 1 in FIG. 1. In this regard, the nonwoven fabric 1 in FIG. 3 has its lower surface 4 placed on a horizontal plane H and its upper surface 3 is loaded thereon with a flat plate made of acrylic resin sized to span the two or more troughs 7 in the transverse direction B and a weight (not shown) so that a total load to the nonwoven fabric 1 may be adjusted to 3 gf/cm². In FIG. 3, the ridges 6 of the nonwoven fabric 1 are defined by regions disposed between the acrylic resin plate 9 and the horizontal plane H and the crests 12 of the respective ridges 6 are defined by regions put in contact with the acrylic resin plate 9 and close to the acrylic resin plate 9. A distance between the acrylic resin plate 9 and the plane H corresponding to thickness T of the nonwoven fabric 1 in the ridges 6 wherein the thickness T is in a range of 1 to 5 mm. In the preferred nonwoven fabric 1, the thickness T is substantially uniform among the respective ridges 6 and, in other words, the acrylic resin plate 9 and the plane H are substantially parallel to each other. In this invention, the thickness T of the ridges 6 is also referred to as “thickness T of the nonwoven fabric 1” or “height T of the ridges 6” as the case may be.

In the nonwoven fabric 1 according to this invention, as illustrated in FIG. 3, each of the ridges 6 includes a central region 21 defined in a middle in the transverse direction B and containing the short fibers 2 distributed at a relatively low density and lateral regions 22, 23 defined on both sides of the central region 21 in the transverse direction B and respectively containing the short fibers 2 at a relatively high density. The distribution density of the short fibers in the central region 21 and the lateral regions can be comparatively measured by procedures as follows: at opposite ends in the cross direction CD of a range in which each of the ridges 6 is put in contact with the acrylic resin plate 9 and included by the lateral regions 22, 23, respectively, second and third vertical lines Y₂, Y₃ which are orthogonal to the plane H are drawn and, right between these second and third vertical lines Y₂ and Y₃ and included by the central region 21, a first vertical line Y₁ which is orthogonal to the plane H is drawn. As will be described later in more details, the number of intersections N₁, N₂ and N₃ corresponding to the number of the short fibers 2 intersecting with these first, second and third vertical lines Y₁, Y₂ and Y₃ may be counted to determine whether the short fibers 2 are distributed at high density or low density. In the nonwoven fabric 1 according to this invention, the number of intersections N₂ as well as the number of intersections N₃ is larger than the number of intersections N₁. The short fibers 2 forming such central region 21 include, in the crest 12 of the ridge 6, short fibers 2a extending in the transverse direction B so as to connect the opposite lateral regions 22, 23 to each other. For reference's sake, a dimension measured along the second and third vertical lines Y₂, Y₃ between the horizontal plane H and the acrylic resin plate 9 is the thickness T of the nonwoven fabric 1.

The troughs 7 in the nonwoven fabric 1 are defined between the adjacent ridges 6 as seen in FIG. 2 so that the upper surface 3 of the nonwoven fabric 1 is sufficiently spaced from the acrylic resin plate 9 to be kept out of contact with the acrylic resin plate 9 in the troughs 7. In other words, the troughs 7 are defined by regions lower than the height T of the ridges 6. Thickness t of the nonwoven fabric 1 in the troughs 7 corresponds to a distance between bottoms 26 of the respective troughs 7 and the plane H. The thickness t in the preferable nonwoven fabric 1 is in a range of 0.1 to 2 mm and at least 0.5 mm thinner than the thickness of the nonwoven fabric 1 in the ridges 6. In the preferred nonwoven fabric 1, a distance between the first vertical lines Y₁ in the adjacent ridges 6 is in a range of 2 to 6 mm, a width of the trough 7 partially occupying this distance is in a range of 0.4 to 2 mm and a width of the respective ridges 6 corresponding to a dimensional difference between the distance of the adjacent first vertical lines Y₁ and the width of the respective troughs is at least 1.5 mm larger than the width of the respective troughs 7.

The short fibers 2 used to form the nonwoven fabric 1 have fineness in a range of 1.0 to 8 dtex, more preferably in a range of 2.2 to 4 dtexs, fiber length in a range of 5 to 75 mm, more preferably in a range of 25 to 51 mm and a basis mass in a range of 20 to 80 g/m². The short fibers 2 may also be used in the form of mixture of short fibers being different in fineness and/or in fiber length. As the thermoplastic synthetic resins forming the short fibers 2, for example, polyethylene, polypropylene, nylon or polyester may be used. In addition, it is also possible to use conjugate fibers formed from two or more kinds of these synthetic resins as the short fibers 2. As the conjugate fibers, not only concentric or eccentric core-sheath type conjugate fibers but also side-by-side type conjugate fibers may be used. In the nonwoven fabric 1, the short fibers 2 are preferably fused together so that, during use thereof, the shapes of the ridges 6 and the troughs 7 as exemplarily illustrated may be easily retained.

Assumed that the nonwoven fabric 1 having been formed in this manner is used as a liquid-permeable topsheet adapted to cover a bodily fluid-absorbent core material assembly of a disposable diaper, the crests 12 of the respective ridges 6 primarily come into contact with the wearer's skin and the troughs 7 are kept out of contact with the wearer's skin. Consequently, gaps are defined between the skin and the troughs to ensure air flow and thereby to alleviate a feeling of wetness which would otherwise be created against the wearer. In addition, even if bodily fluids once absorbed by the core material assembly flow back toward the skin, such bodily fluids may stay in the troughs 7 and the wearer's skin should not be wetted therewith.

In the nonwoven fabric 1, the troughs 7 having the thickness t ever smaller than the thickness T of the ridges 6 assure bodily fluids to permeate the nonwoven fabric quickly toward the core material assembly and the middle areas 21 of the respective ridges 6 also assure bodily fluids to permeate the nonwoven fabric quickly since the short fibers 2 are sparsely distributed and have correspondingly small number of intersections N₁ in the respective middle areas 21. In the lateral regions 22, 23 of the respective ridges 6, the short fibers 2 are densely distributed and have correspondingly large number of intersections N₂, N₃. In consequence, these lateral regions 22, 23 are not easily deformable and assure the respective middle areas 21 to retain the initial shapes thereof during use of the diaper. The short fibers 2a as a part of the short fibers 2 extend in the crest 12 of the ridge 6 in the transverse direction B so as to connect the opposite lateral regions 22, 23 to each other. These short fibers 2a make the wearer feel as if the upper surface 3 is defined by the continuously flat crests 12 when the wearer's skin comes in contact with the crests 12 in spite of the fact that the middle areas 21 are nearly in void state. In other words, these short fibers 2a do not make the wearer feel the middle areas 21 as gaps which are defined between the respective pairs of the opposite lateral regions 22, 23. In fact, each of the ridges 6 of the nonwoven fabric 1 is divided into a first ridge including the lateral region 22 and a second ridge including the lateral region 23 but these first and second ridges are connected to each other by the short fibers 2a so that air permeability as well as liquid permeability may be improved and smooth texture may be ensured.

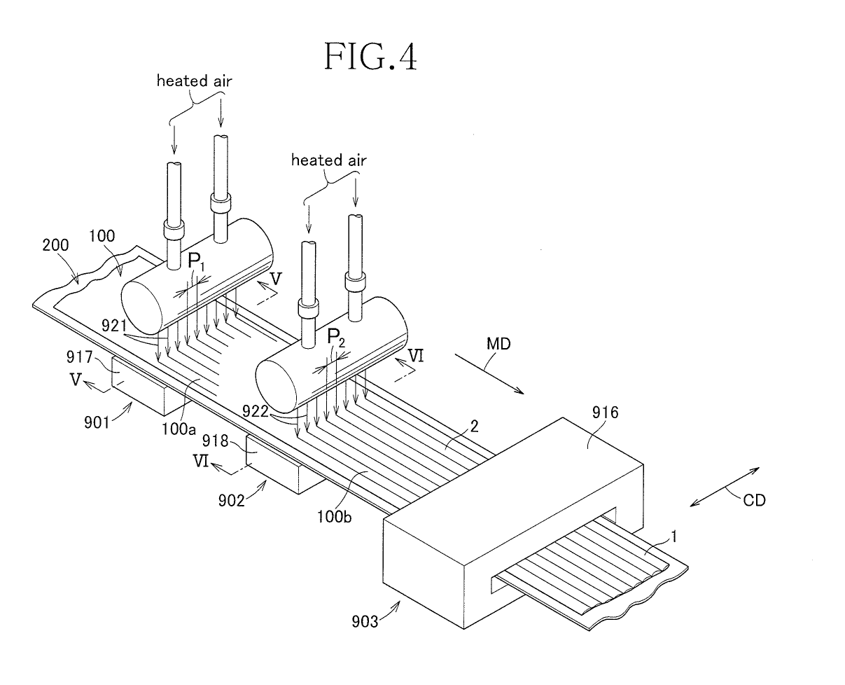

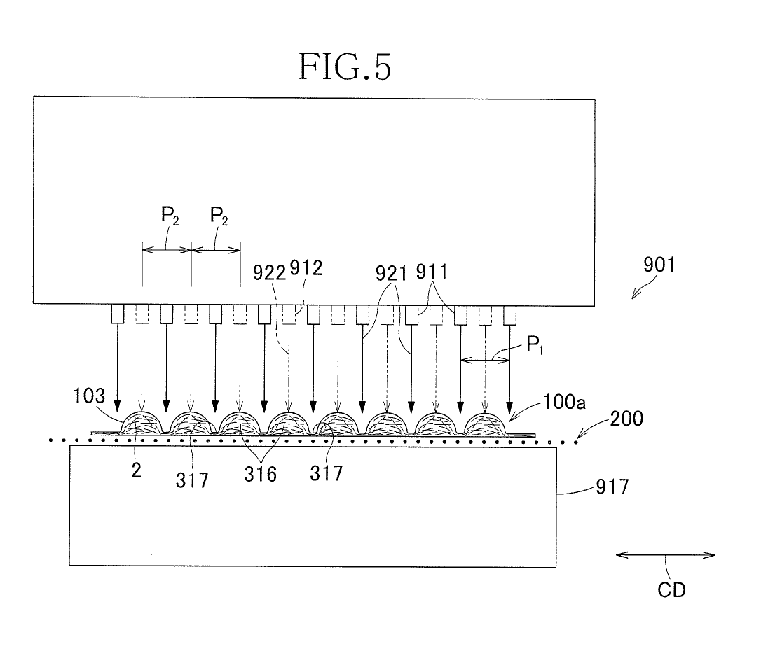

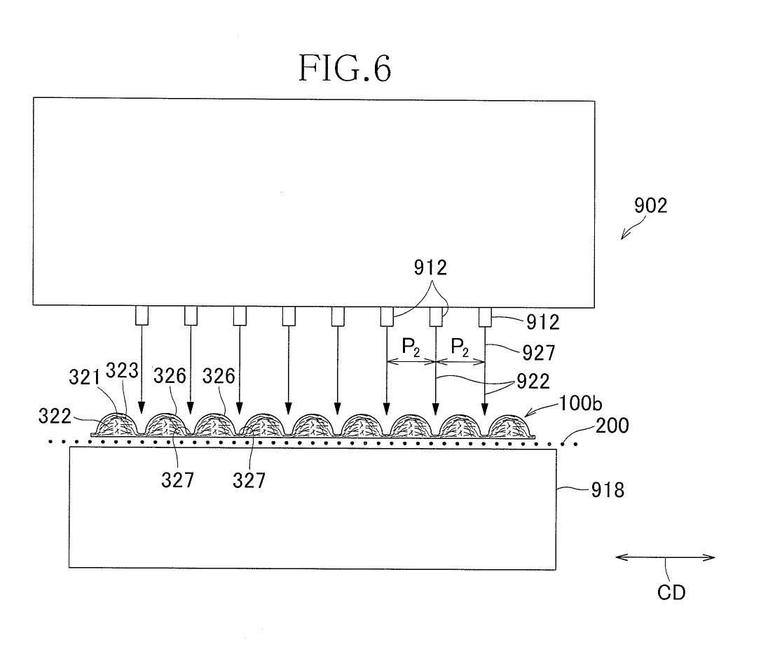

FIG. 4 is a diagram exemplarily illustrating a part of the manufacturing process for the nonwoven fabric 1 wherein the illustrated part of the process includes a portion of an endless belt 200 loaded with a carded web 100 having a substantially uniform thickness and running in a machine direction MD, a first step 901 of subjecting the web 100 to primary treatment, a second step 902 of subjecting a first processed web 100a to secondary treatment and a third step 903 of subjecting the second processed web 100b to heat treatment. As the belt 200, air-permeable mesh belt having an open area ratio, for example, corresponding to 30 meshes or more is used so that the web 100 may be subjected to a suction effect provided from below the belt 200. The web 100 is obtained by carding (not shown) an assembly of the short fibers 2 and this web 100 is sequentially treated in the first, second and third steps to obtain the nonwoven fabric 1. In the illustrated process, for example, core-in-sheath type conjugate fiber composed of polyester as the core and polyethylene as the sheath and having a fineness of 2.5 dtex and a fiber length of 51 mm is used as the short fibers 2. As the web 100, a carded web containing such short fibers 2, for example, at a mass per unit area of 40 g/m² is used. The first step 901 involves a plurality of first nozzles 911 (See FIG. 5) arranged at a required pitch P₁ in a cross direction CD orthogonal to the machine direction MD so as to extend across the belt 200. The first nozzles 911 eject first air jets 921 toward the web 100 to obtain the first processed web 100a from the web 100. The second step 902 involves a plurality of second nozzles 912 (See FIGS. 5 and 6) arranged at a required pitch P₂ in the cross direction CD. The second nozzles 912 eject second air jets 922 toward the first processed web 100a to obtain second processed web 100b. The third step 903 involves a heat treatment chamber 916 within which hot air at a required temperature is circulating and, in this chamber 916, the second processed web 100b having left the second step 902 is subjected to heat treatment to obtain the nonwoven fabric 1. The machine direction MD and the cross direction CD in FIG. 4 correspond to the longitudinal direction A and the transverse direction B in FIGS. 1 and 2, respectively.

FIG. 5 is a sectional diagram taken along line V-V in FIG. 4 and illustrates, in addition to the first nozzles 911 arranged in the cross direction CD and a cross-sectional shape of the first processed web 100a having been subjected to the treatment by the first air jets 921, the other members such as the belt 200 and a first suction box 917 set up immediately below the belt 200. Passing through the first step 901 of FIG. 4, the web 100 is subjected to ejection of the first air jets 921 from above. In the web 100 having been subjected to ejection of the first air jets 921, the short fibers 2 lying immediately below the first nozzles, respectively, are forced to move toward both sides in the cross direction CD and to be divided into substantially equal two parts. Consequently, the upper surface 103 of the web 100 is formed in regions immediately below the first nozzles 911 with primary troughs 317 and formed in regions below the middle points between the adjacent nozzles 911 with primary ridges 316. In this manner, the first processed web 100a is obtained from the web 100. The first air jets 921 are heated at a temperature sufficiently high to assure that, at some of intersections of the short fibers 2 in the primary ridges 316 and the primary troughs 317, the short fibers 2 are fused together. When the conjugate fibers of core (polyester)-in-sheath (polyethylene) type is used as the short fibers 2, the first air jets 921 is heated at a temperature in a range of 110 to 190° C.

FIG. 6 is a sectional diagram taken along line VI-VI in FIG. 4 and illustrates, in addition to the second nozzles 912 arranged in the cross direction CD and a cross-sectional shape of the second processed web 100b having been subjected to the treatment by the second air jets 922, the other members such as the belt 200 and a second suction box 917 set up immediately below the belt 200. Passing through the second step 902 of FIG. 4, the first processed web 100a is subjected to ejection of the second air jets 922 from above. A value of pitch P₂ at which the second nozzles 912 are arranged is equal to the value of the pitch P₁ at which the first nozzles 911 are arranged. However, the second nozzles 912 are arranged to be biased in the cross direction CD with respect to the first nozzles 911 by ½ of the pitch P₁. Specifically, the second nozzles 912 as well as the second air jets 922 are seen between respective pairs of the adjacent first nozzles 911 as indicated by imaginary lines in FIG. 5. Such second air jets 922 are targeted to the middle areas of the respective primary ridges 316 in the first processed web 100a so as to reallocate the short fibers 2 in the primary ridges 316 and the primary troughs 317. Consequently, the second processed web 100b obtained in the second step 902 has the secondary ridges 326 formed in the place of the primary troughs 317 and the secondary troughs 327 in the place of the primary ridges 316. The secondary ridges 326 respectively include, in the cross direction CD, central regions 321 in which the short fibers 2 are sparsely distributed, lateral regions 322, 323 defined on both sides of the respective central regions 321, in which the short fibers 2 are densely distributed. The second air jets 922 are heated at a temperature sufficiently high to assure that, at some of intersections of the short fibers 2 in the secondary ridges 326 and the secondary troughs 327, the short fibers 2 are fused together. For example, in a similar way to the first air jets 921, the second air jets 922 is heated at a temperature in a range of 110 to 190° C. It should be appreciated here that, in this invention, the primary ridges 316, the primary troughs 317, the secondary ridges 326 and the secondary troughs 327 in FIGS. 5 and 6 will be sometimes designated, respectively, as the first ridges 316, the first troughs 317, the second ridges 326 and the second troughs 327 as the case may be.

The second processed web 100b being in such a state in the second step 902 is further conveyed into the heat treatment chamber 916 set up in the third step 903. The heat treatment chamber 916 is adapted to further stabilize the shape of the second processed web 100b having left the second step 902. A temperature of hot air circulating in the heat treatment chamber 916 and a time for which the second processed web 100b stays herein are set so that the short fibers 2 may be fused together at many more intersections. When the conjugate fiber of core (polyester)-in-sheath (polyethylene) is used as the short fibers 2, the second processed web 100b may be left stay for 10 seconds within the heat treatment chamber 916 in which hot air at a temperature of 138° C. is circulated at a wind velocity of 0.7 m/sec.

The web 100 having been sequentially treated in the first, second and third steps 901, 902, 903 in this manner may be used as the nonwoven fabric 1. The secondary ridges 326 and the secondary troughs 327 respectively correspond to the ridges 6 and the troughs 7 in the nonwoven fabric 1 and the central regions 321 and the lateral regions 322, 323 in the secondary ridges 326 respectively correspond to the central regions 21 and the lateral regions 22, 23.

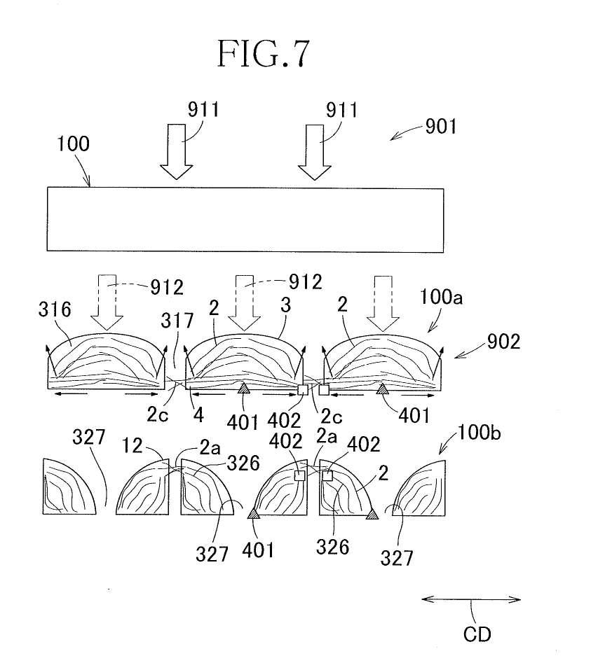

FIG. 7 is a diagram schematically illustrating a mechanism according to which the central regions 21 and the opposite lateral regions 22, 23 of the respective ridges 6 in the nonwoven fabric 1 are formed from the web 100. While it was impossible for the inventors to make certain of this mechanism, on the basis of results of observation in Examples and Comparative Examples to be described later in detail, the inventors were able to presume this mechanism, though roughly. Specifically, in the first step, the web 100 is subjected to ejection of the first air jets 921 to obtain the first processed web 100a having the primary ridges 316 and the primary troughs 317 wherein the primary troughs 317 contain short fibers 2c among the short fibers 2. On the lower surface 4 of the first processed web 100a, triangular marks 401 are put on middles in the cross direction CD of the respective primary ridges 316 and rectangular marks 402 are put on bottoms of the ridges. In the second step 902 in FIG. 4, the primary ridges 316 are subjected to ejection of the second air jets 922 to change the first processed web 100a to the second processed web 100b having the secondary ridges 326 and the secondary troughs 327. In these secondary ridges 326, many short fibers 2c gather together in the crests 12 extending in respective middles in the cross direction CD and these short fibers 2c are apt to become short fibers 2a (See FIG. 3). In addition, the marks 401 and the marks 402 are apt to move to the illustrated positions.

### EXAMPLES

### Examples 1-3

As the short fibers according to this invention, concentric core (polyester)-in-sheath (polyethylene) type conjugate fiber having a fineness of 2.6 dtex and a fiber length of 51 mm was used and a carded web formed of these short fibers and having a mass per unite area of 30 g/m² was loaded on the air-permeable belt in the process illustrated in FIG. 4 and conveyed in the machine direction at a velocity of 10 m/min. As the first and second nozzles respectively involved in the first and second steps illustrated in FIG. 4, the nozzles each having an inner diameter of 1.0 mm were used and both the first and second nozzles were arranged at a pitch of 4 mm in the cross direction. Temperature and airflow of the first and second air jets were set as indicated in TABLE 1. Within the heat treatment chamber of the third step, hot air at a temperature of 138° C. was circulated at a velocity of 0.7 m/sec and the web was left stay therein for 10 seconds for the heat treatment. In this way, Examples 1-3 of nonwoven fabrics according to this invention were obtained. The nonwoven fabrics had the ridges 6 and the troughs 7 exemplarily illustrated in FIGS. 2 and 3 wherein the ridges 6 included the central regions 21 and the opposite lateral regions 22, 23. For the respective nonwoven fabrics of Examples, thickness, mass per unit area, specific volume, the number of fiber intersections in the central region, the number of fiber in the lateral region, ratio of the number of fiber intersections between the central region and the lateral region, permeability rate of artificial urine, smoothness of the upper surface and air-permeability were measured under measurement conditions to be described in detail later and measurement results were indicated in TABLE 2.

### Comparative Example 1

The same web as that used in Example 1 was used. In this regard, however, the treatment in the second step of the process illustrated in FIG. 4 was eliminated and the nonwoven fabric according to Comparative Example 1 was obtained by treatment in the first step and the third step. While the nonwoven fabric was formed with the ridges and the troughs, none of the central region and the lateral regions according to this invention was observed. In Comparative Example 1, the first step was implemented under the condition as indicated in TABLE 1. For the nonwoven fabric having been obtained under such condition, the same items as those for Examples were measured and the result thereof were indicated in TABLE 2.

### Comparative Example 2

Also in Comparative Example 2, the same web used in Example 1 was used. In this regard, however, as will be apparent from TABLE 1, the first and second steps were eliminated and the nonwoven fabric according to Comparative Example 2 was obtained by the treatment in the third step only. This nonwoven fabric had neither the ridge nor the trough and had a substantially uniform thickness. For the nonwoven fabric having been obtained under such condition, the same items as those for Examples were measured and the result thereof were indicated in TABLE 2.

TABLE 1

| | Conditions for manufacturing | | | | | | | |
|---|---|---|---|---|---|---|---|---|
| | nonwoven fabric | | | | | | | |
| | First step | | | | Second step | | | |
| | | | First air jets | | | | Second air jets | |
| | | | | Airflow | | | | Airflow |
| | Nozzle | | | rate | Nozzle | | | rate |
| | diameter | Nozzle pitch | Temperature | (l/min/ | diameter | Nozzle pitch | Temperature | (l/min/ |
| | (mm) | (mm) | (° C.) | nozzle) | (mm) | (mm) | (° C.) | nozzle) |
| Example 1 | 1 | 4 | 180 | 3.5 | 1 | 4 | 180 | 3.5 |
| Example 2 | 1 | 4 | 180 | 4 | 1 | 4 | 180 | 4 |
| Example 3 | 1 | 4 | 180 | 6 | 1 | 4 | 180 | 6 |
| Comparative Example 1 | 1 | 4 | 180 | 6 | | | | |
| Comparative Example 2 | | | | | | | | |

TABLE 2

| | | | | Comparative | Comparative |
|---|---|---|---|---|---|
| Samples | Example 1 | Example 2 | Example 3 | Example 1 | Example 2 |
| Thickness (mm) | 1.35 | 1.43 | 1.41 | 1.42 | 1.62 |
| Mass per unit area (g/m²) | 31.8 | 31.2 | 31.2 | 32.3 | 31.8 |
| Specific volume (cc/g) | 42.6 | 45.9 | 45.1 | 44.0 | 50.9 |
| Number of intersections in central region N₁ | 14 | 15 | 9 | 28 | |
| Number of intersections in lateral region N₂ | 19 | 22 | 18 | 25 | |
| Number of intersections in lateral region N₃ | 20 | 20 | 19 | 28 | |
| N₁/N₂ | 74% | 68% | 50% | 112% | |
| N₁/N₃ | 70% | 75% | 47% | 100% | |
| Artificial urine permeability (s) | 1.55 | 1.30 | 1.05 | 1.92 | 3.32 |
| Surface smoothness (MMD) | 0.0108 | 0.0098 | 0.0109 | 0.0099 | 0.0109 |
| Permeability resistance value | 0.0091 | 0.0089 | 0.0054 | 0.0115 | 0.0156 |

### {Evaluation Items and Measuring Conditions}

Evaluation items selected for Examples 1-3 of the nonwoven fabric and Comparative Examples 1 and 2 of the nonwoven fabric and measuring conditions for the respective items are described below.

### 1. Thickness:

A disc having a diameter of 4.4 cm and a weight of 41.5 g is put on the nonwoven fabric of 100×100 mm placed on a horizontal plane so as to subject the nonwoven fabric to a surface pressure of 3 gf/cm². Then the contact shoe of the dial gauge is put in contact with the disc to measure a total thickness of the disc and the nonwoven fabric. Thickness difference between the total thickness and the thickness of the disc is calculated. Average value of these differences is calculated on ten (10) sheets of the nonwoven fabric to obtain the thickness T (mm) of the nonwoven fabric.

### 2. Mass Per Unit Area:

The nonwoven fabric of 100×100 mm is weighed with use of an electronic force balance and an average value w (g) of weight for ten (10) sheets of the nonwoven fabric. The mass per unit area W (g/m²) is obtained according to the following formula:

Mass per unit area W (g/m²)=w (g)×100

### 3. Specific Volume:

From the thickness T and the mass per unit area W, a specific volume is calculated according to the following formula:

Specific volume (cc/g)=thickness T (mm)/mass per unit area W (g/m²)×1000

### 4. Number of Fiber Intersections in the Central Region and the Lateral Region of the Respective Ridges:

(1) With use of Replacement Blade HA-100B dedicated for Cutter Knife HA-7NB (Trade Name) manufactured by Kokuyo CO., LTD., the nonwoven fabric is cut in a direction (cross direction) orthogonal to a direction (machine direction) in which the ridges extend to prepare a cut surface for observation extending in parallel to the cross direction.

(2) The cut surface prepared nonwoven fabric is placed on a horizontal plane and a flat plate (not shown) having a sufficient size to span a plurality of the troughs 7 in the transverse direction B is put on the upper surface of the nonwoven fabric so that the nonwoven fabric may be subjected to a load of 3 gf/cm².

(3) The cut surface of the nonwoven fabric having a thickness compressed under the load is observed with use of Real Surface View Microscope VE-7800 manufactured by Keyence Corporation) and a photograph of 30-fold magnifications is taken.

(4) In this enlarged photograph, at the regions defining opposite ends in the cross direction in a range which the upper surface of the nonwoven fabric is put in contact with the flat plate vertical lines Y₂, Y₃ which are orthogonal to the horizontal plane are drawn and, right between these vertical lines Y₂ and Y₃, a vertical line Y₁ which is orthogonal to the horizontal plane is drawn (See FIG. 3).

(5) With respect to these vertical lines Y₁, Y₂ and Y₃, the number of intersections of the short fibers is respectively counted. The number of intersections of the vertical line Y₁ and the short fibers is designated as N₁, the number of intersections of the vertical lines Y₂, Y₃ and the short fibers are designated as N₂, N₃, respectively.

### 5. Ratio of the Number of Intersections:

(1) Ratios of the number of intersections between the central region and the one lateral region and between the central region and the other lateral region, i.e., N₁/N₂ and N₁/N₃ are calculated.

### 6. Permeability Rate of Artificial Urine (Sec):

As the measuring device, EDANA-ERT manufactured by Lenzing Technik GmbH is used and as the measuring condition, Section 150.3 Liquid Strike Through Time method is adopted. As the test liquid, artificial urine of which composition is described later is prepared. Using 5 ml of the artificial urine, a permeability rate (sec) of the artificial urine through the nonwoven fabric of 100×100 mm is measured and an average value is calculated from the permeability rates measured on ten (10) sheets of the nonwoven fabric.

(Composition of the Artificial Urine)

Solution of 200 g of urea, 80 g of sodium chloride, 8 g of magnesium sulfate, 3 g of calcium chloride and about 1 g of pigment (Blue No. 1) in 10 liter of ion-exchanged water.

### 7. Surface Smoothness

(1) 100×100 mm sheets of the nonwoven fabric are prepared as test pieces.

(2) As the measuring device, Surface Friction Tester KES-FB4-AUTO manufactured by KATO TECH CO., LTD. is used. Setting a value of SENS to STD, a value of weight to 50 g and a measuring terminal to 5×5 mm, a friction coefficient on the upper surface of the nonwoven fabric is measured in the machine direction in which the ridges extend. An average value is calculated from three (3) sheets of the nonwoven fabric as the value representing the smoothness (NB: according to this measuring method, the larger the value, the poorer the smoothness).

### 8. Airflow Resistance Value:

(1) 100×100 mm sheets of the nonwoven fabric are prepared as test pieces.

(2) As the measuring device, Air Permeability Tester KES-F8-A91 manufactured by KATO TECH CO., LTD. is used. Setting a standard air permeability rate to 2 cm/sec, the airflow resistance value is measured. An average value calculated from measured values obtained on ten (10) sheets of a nonwoven fabric is adopted as the airflow resistance value.

As will be apparent from TABLE 2, the nonwoven fabrics according to Examples respectively have high artificial urine permeation rates, smooth surfaces and low airflow resistance values.

1. A nonwoven fabric formed of thermoplastic synthetic resin short fibers fused together having a longitudinal direction, a transverse direction and a thickness direction being orthogonal to each other, including an upper surface and a lower surface opposite to the upper surface as viewed in the thickness direction wherein the upper surface is formed with ridges and troughs extending in parallel to each other and alternating in the transverse direction so as to undulate in the transverse direction, wherein:
in a cross section taken in the transverse direction, each of the ridges includes opposite lateral regions in which the short fibers are densely distributed and a central region defined between the opposite lateral regions, in which the short fibers are sparsely distributed and the short fibers in the central region include the short fibers extending in a crest of the ridge in the transverse direction to connect the opposite lateral regions.

2. The nonwoven fabric defined by claim 1, wherein, in a state of the nonwoven fabric placed on a horizontal plane so that the lower surface may rest on the horizontal plane, the upper surface in the opposite lateral regions lies at a height in a range of 1 to 5 mm from the horizontal plane and the upper surface in the trough lies at a height lower than the height of the opposite lateral region, i.e., in a range of 0.1 to 2 mm from the horizontal plane.

3. The nonwoven fabric defined by claim 2, wherein, in the ridge of the nonwoven fabric placed on the horizontal plane and subjected to a load of 3 gf/cm² from the side of the upper surface by means of a flat plate stacked on the upper surface, the number of intersections N₁ of a vertical line Y₁ extending through the central region and the short fibers is smaller than any one of the number of intersections N₂, N₃ of vertical lines Y₂ and Y₃ extending through the opposite lateral regions and the short fibers.

4. Method for manufacturing the nonwoven fabric defined by claim 1 including the steps of:
(a) Placing a web formed of thermoplastic synthetic resin short fibers and having an upper surface and a lower surface on air-permeable supporting means, conveying the web in a machine direction under a suction effect provided from below the support means and subjecting the upper surface of the web to ejection of heated first air jets to form a plurality of first nozzles arranged at a required pitch in a cross section being orthogonal to the machine direction to obtain a first processed web having the upper surface formed with a plurality of first ridges and first troughs arranged alternately in the cross direction and extending in parallel to each other in the machine direction;
(b) Subjecting the upper surface in the respective first ridges of the first processed web running in the machine direction to ejection of heated second air jets from a plurality of second nozzles arranged at a required pitch in the cross direction to obtain a second processed web including, in the cross section in the cross direction, a central region defined between the opposite lateral regions in which the short fibers are densely distributed and the short fibers are distributed more sparsely than in the opposite lateral regions and additionally including a plurality of second ridges extending in the machine direction and a plurality of second troughs defined between the adjacent second ridges and extending in the machine direction; and
(c) Heat-treating the second processed web to fuse the short fibers together.
